(19) United States
(12) Patent Application Publication
(10) Pub. No.: US 2017/0204320 A1
(43) Pub. Date: Jul. 20, 2017

(54) Low Pour-Point Lubricant Additives For Oiled-Based Muds and Synthetic-Based Muds Lubricant Additives for Wellbore or Subterranean Drilling Fluids or Muds

(71) Applicant: Dover Chemical Corporation, Dover, OH (US)

(72) Inventors: Duong Nguyen, Dover, OH (US); Ben Rohr, Bolivar, OH (US); Don STEVENSON, Dover, OH (US)

(21) Appl. No.: 15/407,596

(22) Filed: Jan. 17, 2017

Related U.S. Application Data
(60) Provisional application No. 62/280,919, filed on Jan. 20, 2016.

(51) Int. Cl. C09K 8/34; C10M 159/12

(52) U.S. Cl. CPC C09K 8/34; C10M 159/12; C09K 2208/34

(57) ABSTRACT

A lubricant composition having the non-water reaction products produced by a process having the step of reacting the following-three reactants in a condensation reaction:

i) oleic acid,
ii) triethanolamine, and
iii) a polyol selected from the group consisting of pentaerythritol and trimethylolpropane.

### CROSS-REFERENCE TO RELATED APPLICATIONS

This U.S. non-provisional patent application claims priority to U.S. provisional patent application titled, “Lubricant Additives For Wellbore or Subterranean Drilling Fluids or Muds” having provisional patent application Ser. No. 62/280,919 and filed on Jan. 20, 2016. All subject matter within the 62/280,919 provisional patent application is hereby incorporated by reference into this application.

### BACKGROUND OF THE INVENTION

During drilling operations for oil-and-gas explorations, a drilling fluid or mud is typically circulated through the well bore to facilitate the drilling process. This shortens the drilling time by lubricating the rotary drill bits that are located at the end of the drill pipe string, and also by lubricating the drill pipe string that can stick or rub against the borehole causing undesirable increased friction, energy loss, misdirection of the drilling, and eventual slowing of the drilling process. The drilling mud is also designed to carry out cuttings or debris generated by drilling and to stabilize the well-bore formation. Stabilization of the well-bore formation occurs because the drilling fluid or mud exerts hydrostatic pressure on the well-bore wall and thereby helps to maintain the well-bore-wall integrity.

Drilling muds can be categorized according to their base: water-based muds (WBM), oil-based muds (OBM), and synthetic-based muds (SBM). WBM typically include bentonite clay or polymeric (solids-free) thickeners to suspend or thicken the aqueous continuous phase that can be derived from fresh water or salt solutions (or brines) as in brine muds (BRM). OBM or invert-emulsion water-in-oil mud commonly has 50:50 to 95:5 blend ratios of oil to water in which oil is the continuous phase. The continuous hydrocarbon phase in OBM can be diesel, mineral oil, natural vegetable oils, synthetic esters, olefins, or combinations thereof. Very generally, OBM is understood by persons of ordinary skill in the art to be a broad term that includes both regular OBM and SBM. The difference between the regular OBM and SBM qualifications lies in the different continuous phases. Regular OBM generally has a continuous phase that is petroleum oil, mineral oil, diesel fuel, or combinations thereof. But SBM has a continuous hydrocarbon phase that is vegetable oil, synthetic esters, olefins, or combinations thereof.

Apart from their different continuous phases, the commonly used components of WBM, OBM, and SBM include:

(a) Bentonite clay thickener for WBM or organophilic clay for OBM (SBM);

(b) Fluid-loss reducers or filtrate reducers that are typically water-dispersible polymers designed to stop the water component of a mud from penetrating into the drier surroundings of a well bore or vice versa, i.e., to stop subterranean water from penetrating into the well bore or newly drilled formation by softening and collapsing it. These additives are also used to prevent water from diffusing into the drilling mud and altering its physical characteristics and therefore its designed functions. Illustrative and non-limiting examples of these additives illustrated herein are Baker Hughes' Xanplex® D or xanthan gum, Drilling Specialties Company's Drispac® Superflow or polyanionic cellulosic polymer, and Baker Hughes' BioLose® or non-fermented chemically modified starch;

(c) Thinners or deflocculants; a non-limiting exemplary list including Drilling Specialties' Desco® deflocculant that is a tannin-based thinner;

(d) Barite or barium sulfate, one of the more effective weighting materials used to increase the drilling-mud density; and consequently, to improve the mud's effective hydrostatic pressure underground;

(e) Rev-Dust®, manufactured by Milwhite Inc., an abrasive calcium montmorillonite commonly used to simulate effects of reactive drilled solids or cuttings;

(f) pH adjusters and other inorganic components such as sodium hydroxide or caustic, sodium chloride salt, lime, hydrated calcium chloride in brine;

(g) Amine or sodium alkylated sulfonates that are used as water-in-oil emulsifiers in OBM formulas. For the purposes of examples contained later in this application, this component will be excluded to isolate the lubricity of the novel additive alone without taking into the beneficial or synergistic effect of a sulfonate emulsifier; and

(h) Lubricants—this additive class can be fatty acid, fatty amides and esters, phosphates, sulfurized, and chlorinated hydrocarbons. The lubricants are added into drilling fluids to reduce friction or torque and thereby assist in speeding up the drilling rate with much less energy and time being consumed. Fatty esters and amides also have a significant advantage by being a renewable, non-toxic, biodegradable, and environmentally friendly friction reducers.

Some exemplary patent references dealing with the use of fatty esters as the lubricant in drilling muds are illustrated in U.S. Pat. Nos. 4,964,615; 5,318,956; and 5,618,780; as well as in published United States Patent Application No. 2010/0305009A1; and also in published PCT Patent Application No. WO 2011/019722 A2.

### BRIEF SUMMARY OF THE INVENTION

A lubricant composition having the non-water reaction products produced by a process having the step of reacting the following-three reactants in a condensation reaction:

i) oleic acid,

ii) triethanolamine, and

iii) a polyol selected from the group consisting of pentaerythritol and trimethylolpropane.

A mud-containing fluid having an oil-based or synthetic-based mud-containing fluid; and

the non-water reaction products produced by a process having the step of reacting the following-three reactants in a condensation reaction:

i) oleic acid,

ii) triethanolamine, and

iii) a polyol selected from the group consisting of pentaerythritol and trimethylolpropane.

A lubricant composition having the non-water reaction products produced by a process having the step of reacting the following-three reactants in a condensation reaction:

i) fatty acids, carboxylic acids, or combinations thereof;

ii) alkanolamines; and

iii) polyols.

A mud-containing fluid having an oil-based or synthetic-based mud-containing fluid; and

the non-water reaction products produced by a process having the step of reacting the following-three reactants in a condensation reaction:

i) fatty acids, carboxylic acids, or combinations thereof;

ii) alkanolamines; and

iii) polyols.

### DETAILED DESCRIPTION OF THE INVENTION

Embodiments are generally directed to lubricant compositions that are useful in drilling muds.

Lubricant-composition embodiments generally include the non-water reaction products that result from reacting the following-three types of reactants in a condensation reaction within a single reaction vessel:

i) fatty acids, carboxylic acids, and combinations thereof;

ii) alkanolamines and combinations thereof; and

iii) polyols or combinations thereof.

Fatty acids, carboxylic acids, alkanolamines, and polyols can all be understood to have their ordinary meaning, and it's well known that all of the above reactants are commercially available. Non-water reaction products can be understood as being all reaction products that are not water.

Useful fatty acids and carboxylic acids include: all well known fatty acids such as stearic acid, lauric acid, oleic acid, linoleic acid, ricinoleic acid, dimer acid, and tall oil fatty acid.

Useful alkanolamines include: monoethanolamine (MEA), diethanolamine (DEA), triethanolamine (TEA), mono-isopropanolamine (MiPA), di-isopropanolamine (DiPA), and tri-isopropanolamine (TiPA). Other alkanolamines such as ethoxylated fatty amines can also be used to make the lubricant-composition embodiments.

Useful polyols include: glycols, pentaerythritol, trimethylolpropane, neopentyl glycols, polyethylene glycols, polypropylene glycols, or any alcohol that has more than one hydroxyl group in its chemical structure.

In an embodiment, the reactants used to manufacture the non-water reaction products are:

i) oleic acid;

ii) triethanolamine; and

iii) pentaerythritol.

In another embodiment, the reactants used to manufacture the non-water reaction products are:

i) oleic acid;

ii) triethanolamine; and

iii) trimethylolpropane.

The above-described reaction is a condensation reaction that by definition yields both water and other non-water reaction products. Of the reaction products yielded in the overall condensation reaction, embodiments are directed to using only the non-water reaction products in the lubricant-composition embodiments.

In manufacturing the lubricant composition, the non-water reaction products must be separated from the water reaction product and any known separation method can be employed. As a non-limiting example, water can be separated or removed from the non-water reaction products using known nitrogen-sweep methods. In other embodiments, nitrogen-sweep methods can be used in combination with stopping the reaction after AV or acid number in mg KOH per gram of sample goes below 25.

Because condensation reactions are well known, persons of ordinary skill in the art will be able to discover useful reaction conditions (for yielding the non-water reaction products) without having to exercise undue experimentation. Useful reaction conditions may include a catalyst. Non-limiting examples of useful reaction conditions are shown below in the Examples section.

Useful amounts of each of the above-listed reactants can be discovered by persons of ordinary skill in the art without having to exercise undue experimentation. As a non-limiting example, useful amounts or ratios of reactants can be determined based at least in part on the Examples provided below.

In an embodiment, the lubricant composition may be used in a drilling fluid or mud in an amount ranging from 0.1% to 10% by weight of the total weight of the drilling fluid (including the weight of the lubricant composition). In another embodiment, the lubricant composition may be used in a drilling fluid or mud in an amount ranging from 0.1% to 5.0% by weight of the total weight of the drilling fluid (including the weight of the lubricant composition). In still another embodiment, the lubricant composition may be used in a drilling fluid or mud in an amount ranging from 0.1% to 1.0% by weight of the total weight of the drilling fluid (including the weight of the lubricant composition). In still another embodiment, the lubricant composition may be used in a drilling fluid or mud in an amount that is approximately 1.0% by weight of the total weight of the drilling fluid (including the weight of the lubricant composition).

Embodiments provide for using the lubricant composition in a drilling fluid or mud. Drilling muds include water-based drilling mud, oil-based drilling mud, and synthetic-based drilling mud. Each of these types of drilling muds is well known to persons of ordinary skill in the art and can be understood to have their ordinary definition. Very generally, water-based drilling muds typically include bentonite clay or polymeric (solids-free) thickeners to suspend or thicken the aqueous continuous phase that can be derived from fresh water or salt (or brines) as in brine muds. Oil-based muds or invert-emulsion water-in-oil mud typically includes from 50:50 to 95:5 blend ratios of oil to water in which oil is the continuous phase; the continuous hydrocarbon phase in oil-based muds can be diesel, mineral oil, natural vegetable oils, synthetic esters, olefins, or combinations thereof. And as previously mentioned above, synthetic-based mud or SBM is the type of OBM that has natural vegetable oils, synthetic esters, olefins, or combinations thereof as its continuous phase or carrier.

In embodiments, the lubricant composition has a pour point of less than −10° C. In other embodiments, the lubricant composition has a pour point of less than −15° C. In still other embodiments, the lubricant composition has a pour point of less than −20° C.

Very generally, mud compositions that include one-or-more lubricant-composition embodiments exhibit improved friction and torque reduction relative to similar mud compositions that do not include the lubricant composition embodiments. OBM and SBM composition embodiments that include approximately 2% of the lubricant composition show relatively increased friction reduction that is at least 10% (relative to the same OBM or SBM without the lubricant composition). In other embodiments, OBM and SBM composition embodiments that include approximately 2% of the lubricant composition show relatively increased friction reduction that is at least 15% (relative to the same OBM or SBM without the lubricant composition). In still other embodiments, OBM and SBM composition embodiments that include approximately 2% of the lubricant composition show relatively increased friction reduction that is at least 20% (relative to the same OBM or SBM without the lubricant composition). In still other embodiments, OBM and SBM composition embodiments that include approximately 2% of the lubricant composition show relatively increased friction reduction that is at least 25% (relative to the same OBM or SBM without the lubricant composition). In still other embodiments, OBM and SBM composition embodiments that include approximately 2% of the lubricant composition show relatively increased friction reduction that is at least 30% (relative to the same OBM or SBM without the lubricant composition).

### Examples

Non-limiting exemplary embodiments are shown below reacting: i) a polyol, ii) alkanolamine such as triethanolamine, and iii) a fatty acid; for example by reacting a blend of polyols and triethanolamine with oleic acid. The catalyst for such esterification reaction(s) is methanesulfonic acid or MSA. As is well known, the by-product for esterification is water.

As a non-limiting example, a useful esterification method used to synthesize lubricant-composition embodiments can be described as follows: a i) polyol or a blend of two polyols, ii) triethanolamine, and iii) a fatty acid such as oleic acid are charged into a 4-necked round bottom flask that is equipped with a thermometer, nitrogen sparger, a mechanical stirrer, and an off-gas outlet. Nitrogen is introduced and the batch is then mixed and heated gradually to 165 C° to boil off the by-product water. The reaction is stopped and cooled after an acid number of about 10 mg KOH per gram or lower is achieved.

### Exemplary Methods for Manufacturing Lubricant—Composition Embodiments

### Example #1

149 g (1.0 mole) of triethanolamine, 136 g (1.0 mole) of pentaerythritol, 1,825 g (6.5 moles) of oleic acid, 10.7 g MSA catalyst or 0.5 wt % were charged, and cooked according to the general esterification synthetic procedure that is described above.

### Example #2

149 g (1.0 mole) of triethanolamine, 134 g (1.0 mole) of trimethylolpropane, 1,567 g (5.5 moles) of oleic acid, 9.2 g MSA catalyst or 0.5 wt % were charge, and cooked according to the general esterification synthetic procedure that is described above.

### Example #3

149 g (1.0 mole) of triethanolamine, 68 g (0.5 mole) of pentaerythritol, 67 g (0.5 mole) of tirmethylolpropane, 1,710 g (6.0 moles) of oleic acid, 10.0 g MSA catalyst or 0.5 wt % were charge, and cooked according to the general esterification synthetic procedure that is described above.

### Example #4

158 g (1.06 moles) of triethanolamine, 126.1 g (0.94 mole) of tirmethylolpropane, 1,559 g (5.47 moles) of oleic acid, 9.2 g MSA catalyst or 0.5 wt % were charge, and cooked according to the general esterification synthetic procedure that is described above.

List of Tested Lubricant Additives

TABLE I
Tested Lubricant Additives

| | |
|---|---|
| Lubricant 1 | Novel fatty esters, described in Example 1 |
| Lubricant 2 | Novel fatty esters, described in Example 2 |
| Lubricant 3 | Novel fatty esters, described in Example 3 |
| Lubricant 4 | Novel fatty esters, described in Example 4 |

Description of Drilling Mud Types

TABLE II
Water-Based Mud (WBM) compositions

| | WBM | |
|---|---|---|
| Components | (fresh water) | |
| Tap water | 350 | g |
| Bentonite | 25.0 | g |
| Organophilic clay | 0 | g |
| Xanplex ® D xanthan gum) | 0.5 | g |
| Drispac ® Superflow (polyanionic cellulosic | 0.5 | g |
| polymer) | | |
| Desco ® Deflocculant (tannin-based thinner) | 0.5 | g |
| Barite (barium sulfate) | 0 | g |
| NaOH beads | 0.5 | g |
| NaCl salt | 0 | g |
| Lime | 0 | g |
| CaCl₂ hydrate | 0 | g |
| Rev-Dust ® (calcium montmorillonite) | 0 | g |
| C₁₀ olefin | 0 | g |
| Novel Lubricant (1) | 4.0 | g |

| | |
|---|---|
| Oil/Water Ratio (OBM) | N/A |

Note:
The lubricant embodiments are tested at approximately 1 wt %.

The oil-based drilling fluid or oil-based mud (OBM) is a fresh sample of a commercial product made with diesel as its base carrier.

The synthetic-based drilling fluid or synthetic-based mud (SBM) is a fresh sample of a commercial product made with synthetic oligomers or polymers of short chained olefins as its base carrier.

The SBM drilling fluids are more-and-more acceptable and preferred over the OBM or diesel counterpart due to the increasing environmental concerns over the toxicity and biodegradability of spilled muds into waterways and environments surrounding oil rigs.

List of Tested Lubricant Additives—Testing Methodology

The friction or friction reduction in percents of all experimental drilling muds as prepared by the above Table 1 were measured using an EP/lubricity tester such as Fann EP/Lubricity Tester which is the standard instrument in the field of oil and gas exploration. During this test, a hardened steel block rubs against a steel O-ring or cup while being submerged in the tested drilling fluid. A load is applied on the steel block transmitting to the steel ring by applying a constant load of 150 lbs using a lever arm which “squeezes” the steel block and the steel cup that rotates at the speed of 60 rpm. The torque in lb-in was recorded on a digital dial, and friction reduction was calculated based on the torques obtained with a blank mud which contains no lubricant and the one obtained with the same mud containing 2% of the novel lubricants. The generated data supporting a basis for the novelty of this invention is tabulated below in Table III.

Testing Results

TABLE III
Testing Results: Pour points of the Pure Lubricants and % Friction or Torque
Reductions based 1 wt % lubricant used in drilling muds and Ofite Lubricity Test run at 150 lb-
load and 60 rpm condition:

| | Pour | Friction Reduction % | | |
|---|---|---|---|---|
| Lubricant | Points, C. | In WBM | In SBM | In OBM |
| Lubricant 1 (NR = not run) | −5° C. | NR | 14.3% | 23.7% |
| Lubricant 2 | −17° C. | NR | 22.8% | 31.2% |
| Lubricant 3 | −12° C. | NR | 21.4% | 25.0% |
| Lubricant 4 | −21° C. | NR | 28.6% | 25.0% |

Thus, the lubricants could be synthetically designed to strongly demonstrate their friction-reduction capabilities in commercial oil-based drilling fluids or muds (OBM) and commercial synthetic-based drilling fluids or muds (SBM) at below −20 C ambient temperatures at oil-rig sites or exploration sites.

1. A lubricant composition comprising:
the non-water reaction products produced by a process having the step of reacting the following-three reactants in a condensation reaction:
i) oleic acid,
ii) triethanolamine, and
iii) a polyol selected from the group consisting of pentaerythritol and trimethylolpropane.

2. The lubricant composition of claim 1, wherein the polyol is pentaerythritol.

3. The lubricant composition of claim 1, wherein the polyol is trimethylolpropane.

4. The lubricant composition of claim 1, wherein the lubricant composition has a pour point that is less than −10° C.

5. The lubricant composition of claim 1, wherein the lubricant composition has a pour point that is less than −15° C.

6. The lubricant composition of claim 1, wherein the lubricant composition has a pour point that is less than −20° C.

7. A mud-containing fluid comprising:
an oil-based or synthetic-based mud-containing fluid; and
the non-water reaction products produced by a process having the step of reacting the following-three reactants in a condensation reaction:
i) oleic acid,
ii) triethanolamine, and
iii) a polyol selected from the group consisting of pentaerythritol and trimethylolpropane.

8. The mud-containing fluid of claim 7, wherein the non-water reaction products are present in the mud-containing fluid in an amount ranging from 0.1-10.0 weight percent based on total weight of the mud-containing fluid.

9. The mud-containing fluid of claim 7, wherein the non-water reaction products are present in the mud-containing fluid in an amount ranging from 0.1-5.0 weight percent based on total weight of the mud-containing fluid.

10. The mud-containing fluid of claim 7, wherein the non-water reaction products are present in the mud-containing fluid in an amount that is about 1.0 weight percent based on total weight of the mud-containing fluid.

11. The mud-containing fluid of claim 9, wherein the mud-containing fluid has relatively increased friction reduction that is at least 20% relative to the same oil-based or synthetic-based mud-containing fluid that does not include the non-water reaction products.

12. A lubricant composition comprising:
the non-water reaction products produced by a process having the step of reacting the following-three reactants in a condensation reaction:
i) fatty acids, carboxylic acids, or combinations thereof;
ii) alkanolamines; and
iii) polyols.

13. The lubricant composition of claim 12, wherein the fatty acids and carboxylic acids are selected from the group consisting of stearic acid, lauric acid, oleic acid, linoleic acid, ricinoleic acid, dimer acid, tall oil fatty acid, and combinations thereof;
wherein the alkanolamines are selected from the group consisting of monoethanolamine, diethanolamine, triethanolamine, mono-isopropanolamine, di-isopropanolamine, tri-isopropanolamine, and combinations thereof; and
wherein the polyols are selected from the group consisting of glycols, pentaerythritol, trimethylolpropane, neopentyl glycols, polyethylene gloycols, polypropylene glycols, any alcohols that have more than one hydroxyl group, and combinations thereof.

14. The lubricant composition of claim 13, wherein the lubricant composition has a pour point that is less than −20° C.

15. A mud-containing fluid comprising:
an oil-based or synthetic-based mud-containing fluid; and
the non-water reaction products produced by a process having the step of reacting the following-three reactants in a condensation reaction:
i) fatty acids, carboxylic acids, or combinations thereof;
ii) alkanolamines; and
iii) polyols.

16. The mud-containing fluid of claim 15, wherein the non-water reactants are present in the mud-containing fluid in an amount ranging from 0.1-10.0 weight percent based on the total weight of the mud-containing fluid.

17. The mud-containing fluid of claim 15, wherein the non-water reactants are present in the mud-containing fluid in an amount ranging from 0.1-5.0 weight percent based on total weight of the mud-containing fluid.

18. The mud-containing fluid of claim 15, wherein the non-water reactants are present in the mud-containing fluid at approximately 1.0 weight percent based on total weight of the mud-containing fluid.

19. The mud-containing fluid of claim 17, wherein the mud-containing fluid has relatively increased friction reduction that is at least 20% relative to the same oil-based or synthetic-based mud-containing fluid that does not include the non-water reaction products.
